(19) United States
(12) Patent Application Publication
(10) Pub. No.: US 2012/0267971 A1
(43) Pub. Date: Oct. 25, 2012

(54) Electrical Machine, Rotor for Such Machine and a Method for Its Manufacturing

(75) Inventors: Erik Mathias Husum, Trondheim (NO); Alexey Matveev, Trondheim (NO); Tina Skare Pryde, Trondheim (NO); Astrid Rökke, Trondheim (NO); Stig Ove Stornes, Trondheim (NO); Sigurd Övrebö, Levanger (NO)

(73) Assignee: SMARTMOTOR AS, Trondheim (NO)

(21) Appl. No.: 13/516,828

(22) PCT Filed: Dec. 3, 2010
(86) PCT No.: PCT/NO2010/000444

§ 371 Date: Jul. 12, 2012

(30) Foreign Application Priority Data
Dec. 16, 2009 (NO) 20093533

(51) Int. Cl. H02K 1/32; H02K 15/00

(52) U.S. Cl. 310/59; 29/596

(57) ABSTRACT

The purpose is to accommodate large axial channels in a slim electric machine without sacrificing its torque density and radial dimensions. This is possible with a rotor (11) provided with permanent magnets (12) and a stator (13) with slots (15) for coils (20A-c), where the slots (15) are separated by teeth (16, 17), which electrical machine include teeth (17) not carrying coils (20A-c), which teeth (17) are provided with axial channels (18, 18′) protruding into the teeth (17) and neighboring back iron so that an area of the channel (18, 18′) inside the tooth (17) is comparable to or even larger than the an area of the channel (18, 18′) in the back iron. The channels serve for transportation of fluids and other substances through the machine and also to integrate a motor protector, which may be required in down-hole applications. There are also novel manufacturing techniques associated with the new concept.

### FIELD OF THE INVENTION

The invention relates to an electrical machine according to the preamble of claim 1, a rotor for the electrical machine according to claim 10, and a manufacturing method according to claim 15.

The invention relates especially to electrical machines for use in confined radial space like in narrow wells or tunnels. Applications for an electrical machine according to the invention are in oil and gas exploration and extraction (downhole), drilling applications in general, and any other applications where it is important to have a compact stator with axial channels.

### BACKGROUND OF THE INVENTION

In downhole applications it is often required to transport various substances like rock cuttings, water, oil, etc. through an electrical machine. Sometimes it is required to have cables going through the electrical machine as well. It is state of the art to use the gap between rotor and stator for transporting fluids, like oil, but the gap is very narrow, so the flow cannot be considerable. Moreover, solid particles or viscous fluids cannot be transported through the narrow gap. Therefore, having some extra passages through the machine is desirable.

There is a number of electrical machines where axial channels are integrated into iron cores of the electrical machine, but outside the zone directly involved in energy conversion. For accommodation of the channels, the iron cores are just made thicker and thus increasing the diameter of the electrical machine. Examples of such electrical machines are described in:
DE102007006856 (A1) Siemens AG,
GB986682 (A) Ahlstom,
US2006066159 Enomoto,
DE4103154 (A1) Uwe Unterwasser Electric Gmbh,
JP59010155 (A) Tokyo Shibaura Electric Co, and
US2007024129 (A1) Siemens AG.

It is commonly known to provide channels in the stator for cooling. GB986682 is showing a typical configuration of holes for cooling a stator. In this design a relatively large part of the stator diameter is utilized for cooling. This may be suitable when a large mass stator is desirable for mechanical stability but in general such approach, when used for relatively long electrical machines with small diameter, leads to decrease of air gap diameter and corresponding decrease of torque density. In high torque electrical machines it is advantageous to have higher rotor diameter to have a longer torque arm, on which the force is applied. At the same time, when there is a limitation for outer diameter of the electrical machine, the rotor diameter cannot be increased too much, as there should be enough space for the stator laminations and the winding. So, the designer's task is to find optimal air gap diameter.

Common to the established methods is a failing to have optimal diameter of the air gap as the channels are taking considerable space at the periphery of the electrical machine and reduce the zone available for energy conversion. This may be reviewed e.g. in US2006066159 and in DE4103154. In US2006066159 the channels are arranged outside the active materials and therefore no optimal air gap diameter is achieved. In DE4103154 grooves in the outer part of the stator is used for channels, also without achieving optimal diameter of the air gap.

Contrary to US2006066159 and DE4103154, which have no channels integrated in the stator teeth, in the DE1090750 (B1) cooling channels are integrated in an oblique tooth. In addition to cooling the channels in the teeth are used for leveling the reluctance. It is noteworthy that in DE1090750 (B1) the channels are not prolonged into the back iron because almost all losses are considered to be in the teeth zone and the channels has the purpose of removing the heat from losses.

The type of electrical machine described in DE1090750 (B1) is characterized by too thick yoke (back iron), failing to achieve optimal air gap diameter. In U.S. Pat. No. 6,664,692 and NO324241 the back iron thickness is minimized due to the use of a special configuration of concentrated coils design and permanent magnet technology. This technology is especially favorable for integration of axial channels, as only each second tooth carries a coil and those teeth which do not carry coils have trapezoidal shape.

Therefore, the proposed new concept uses the technology described by patents U.S. Pat. No. 6,664,692 and NO324241 as a basis and a starting point.

### OBJECT

The main object of the invention is to accommodate relatively large axial channels in a slim electrical machine without sacrificing its torque density and radial dimensions. It is particularly an object to provide a downhole electrical machine suitable for offshore use with high torque.

A further object is to provide stator channels allowing the inclusion of an integrated protector.

### SUMMARY OF THE INVENTION

An electrical machine according to the invention is described in claim 1. Preferable features of the electrical machine are described in claims 2-9.

A rotor for an electrical machine according to the invention is described in claim 10. Preferable features of the rotor are described in claims 11-14.

A manufacturing method for an electrical machine according to the invention is described in claim 15. Preferable features of the manufacturing method are described in claims 16-21.

More specifically, the novel feature of the electrical machine is that there are axial channels protruding into some of the teeth which are not carrying coils and neighboring back iron, where the area of the channel inside the tooth is comparable to, or even larger, than the area of the channel in the back iron.

This electrical machine may be designed to provide an optimal diameter of the air gap based on the external diameter available and the need for axial channels given.

In addition to the optimal air gap diameter, a rotor structure is introduced which is maximizing the magnetic field in the machine and contributing to a higher torque. The optimal diameter is creating a substantially higher torque than at prior art machines. The particular rotor design also allows omitting the use of laminated back iron in the rotor.

The machine according to the invention is a permanent magnet synchronous machine (PMSM) with concentrated coils forming the winding. This implies a substantial reduction of the thickness of the stator yoke and provides high torque in a low volume.

The electrical machine preferably includes twelve slots, six coils, six teeth carrying coils, and six teeth not carrying coils.

The number of channels may be fewer than six as not all the teeth not carrying coils contain a channel.

The electrical machine preferably includes six or less teeth containing channels.

The slots are preferably closed by non-magnetic or semi-magnetic slot wedges.

The electrical machine is preferably at least partly filled with fluid for pressure compensation.

An outer shell of the electrical machine is preferably exposed to a cooling fluid circulating in the interior of the electrical machine.

Preferably, at least some of the channels form a flow path, extending through the stator, for the transmission of a fluid, for example a wellbore fluid.

The electrical machine preferably includes a rotor provided with means to provide the internal fluid circulation.

Preferably, at least one channel is used for accommodation of a motor protector.

The invention is particularly suitable for downhole applications with relatively narrow openings. The invention allows the design of machines with a high torque without demanding lengths creating mechanical problems.

The invention also comprises a novel rotor, with a shaft and with permanent magnets attached to the shaft, wherein the magnets are segmented and magnetized according to a special pattern, for example magnetized in alternating directions. The permanent magnets or permanent magnet segments are preferably attached to the shaft. The permanent magnets are further preferably provided with an anti-corrosion coating.

The shaft of the rotor is preferably hollow.

Finally, the invention comprises a manufacturing method for an electrical machine, wherein the stator is assembled from a main preassembled stack of laminations and a plurality of arced segments. Each segment preferably acts as a part of back iron.

The manufacturing method preferably includes first fitting the coils into the slots of laminated stack and next installing the arced segments.

The manufacturing method further preferably includes preforming the coils before fitted into the main preassembled stack.

The manufacturing method further preferably includes the use of arced segments made of radially stacked laminations, axially stacked laminations, sintered magnetic body or compacted magnetic powder body.

Further details of the invention will appear from the following description of example embodiments.

### BRIEF DESCRIPTION OF THE DRAWINGS

The invention will be hereafter described with reference to the accompanying drawings, where:

FIG. 1 shows machine cross-section,

FIGS. 2A-F show variants of the channels,

FIG. 3A-C shows schematically three coils of different shape,

FIG. 4 shows an electrical machine with wide channels: (a) without housing, (b) with housing, (c) with hollow shaft,

FIG. 5 shows oil circulation inside the machine,

FIG. 6 shows a half of a rotor comprising a shaft with mounted permanent magnets,

FIG. 7 shows assembly of stator (variant 1),

FIG. 8 shows assembly of stator (variant 2), and

FIG. 9 shows an integrated motor protector.

### DETAILED DESCRIPTION OF THE PREFERRED EMBODIMENTS

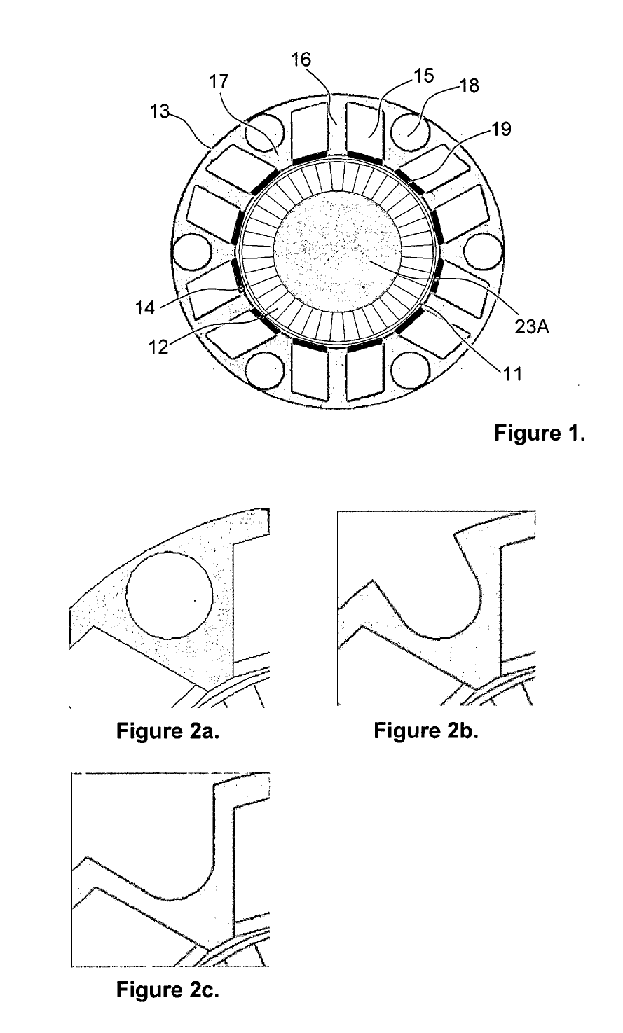

Reference is made to FIG. 1 which shows schematically a first embodiment of an electrical machine according to the invention, with a cross-section of active parts, which has at least three phases and comprises a rotor 11 bearing permanent magnets 12 and a stator 13 bearing phase winding. The permanent magnets 12 are preferably arranged to the rotor 11 by means of a layer 14 for retention and protection of the permanent magnets 12. In the proposed electrical machine, the stator teeth do not need to be identical. A stator tooth configuration according to NO324241 would give an advantage, but is not necessary. The winding consists of coils, each coil extending through a respective pair of stator slots 15 and surrounding one narrow tooth 16, and wherein the neighboring wide tooth 17 not carrying any coil, contain axial channels 18.

In the proposed machine the number of slots 15 is twelve, the number of narrow teeth 16 is six, the number of wide teeth 17 is six and the number of channels 18 is six. In general case the number of teeth can be selected differently, adjusted to speed requirements.

The number of channels 18 may be fewer than six as not all the teeth 17 not carrying coils contain a channel 18.

The slots 15 accommodating the coils are closed by slot wedges 19 with relative permeability equal unity or higher than unity.

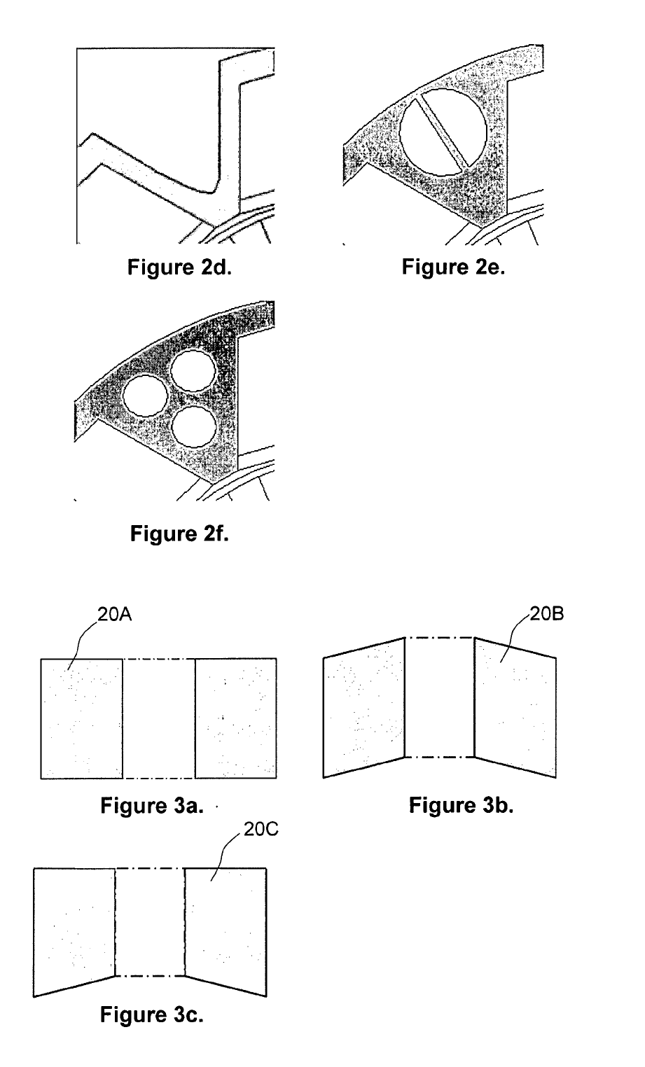

The channels 18 may have various shapes, as shown in FIGS. 2A-F. The common feature for all variants is that the channel 18 protrudes into the tooth 17 so, that area of the channel 18 inside the tooth 17 is larger than in back iron. As shown in FIGS. 2e and 2f the tooth may also include a number of channels.

Reference is now made to FIGS. 3A-C which are showing different forms of coils 20A-C. FIG. 3A is showing coils 20A with a rectangular cross section, FIG. 3B is showing coils 20B shaped with parallel sides, and FIG. 3C is showing coils 20C shaped with non-parallel sides.

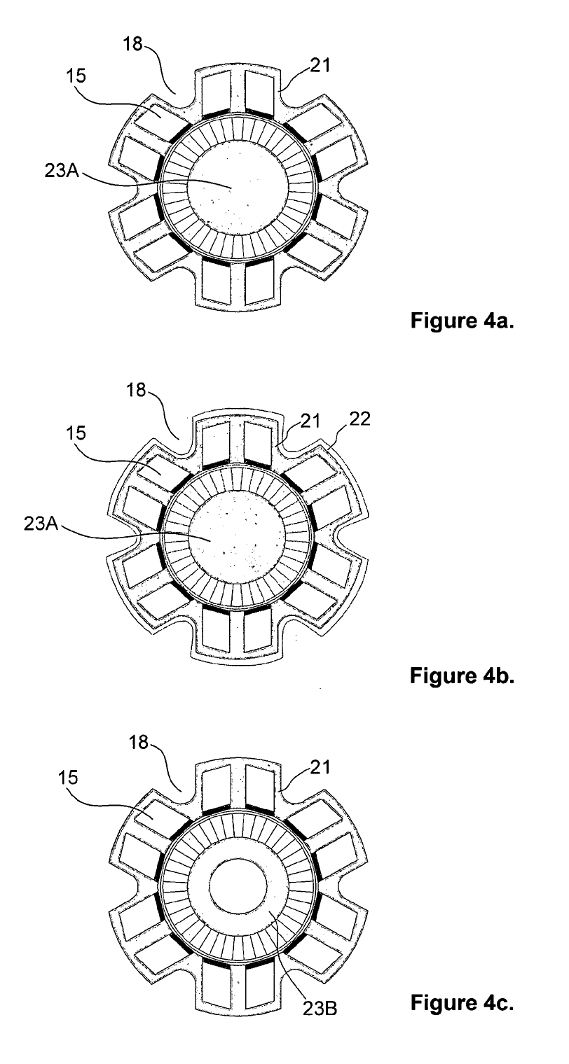

The electrical machine may have its own housing or be integrated into some tool. An alternative with “flower-like” lamination shape 21 with open channels 18 for further integration is shown in FIG. 4A. An alternative with the same laminations 21 and additional housing 22 is shown in FIG. 4B, which additional housing 22 preferably is following the shape of the stator laminations 21. FIGS. 4A and 4B show the use of a solid shaft 23A.

FIG. 4C is showing another example including a hollow shaft 23B without the use of an additional housing 22.

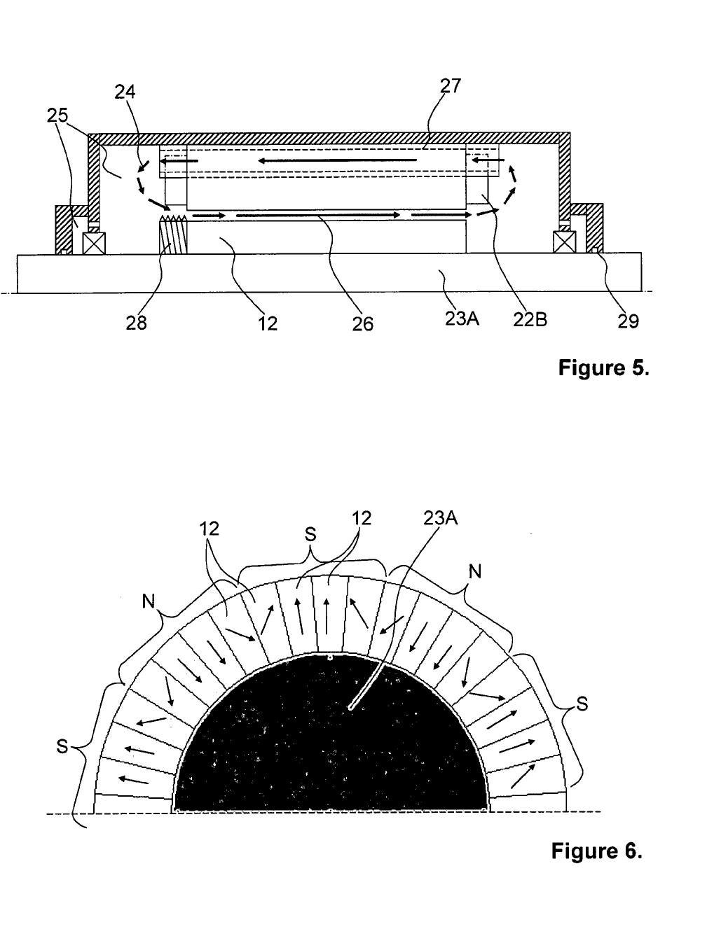

Reference is now made to FIG. 5 which shows circulation of a fluid 24 inside 25 the electrical machine, i.e. also in a gap 26 between the stator and rotor. The requirement in some applications is to fill the electrical machine with a fluid 24 (usually some sort of oil). Therefore, the electrical machine may be cooled by contact of its outer surface with external environment as well as by internal circulation of oil. Contact with the external environment is provided by means of a tube 27 protruding onto a channel 18 through which the fluid 24 flows. One or multiple channels 18 may be used for the circulation as shown in FIG. 5. To arrange the circulation a thread 28 may be arranged on the shaft 23A or on the magnets 12, which thread 28 will force the fluid 24 to flow into the gap 26 between the stator 13 and rotor 11. There are in addition preferably arranged sealings 29 between the shaft 23A and an exterior housing of the electrical machine to prevent the fluid 23 from escaping.

In the machine rotor presented in FIG. 5 the number of poles created by permanent magnets is ten, though in general case, the number of poles may be different from ten.

Reference is now made to FIG. 6 which shows a half of a rotor comprising a solid shaft 23A with mounted permanent magnets 12. The magnets 12 are segmented and magnetized according to a special pattern, for example magnetized in alternating directions (shown by arrows in FIG. 6), to reduce eddy current losses. In the example in FIG. 6 each pole consists of four magnet elements.

To strengthen the magnetic field some of the magnets 12 are magnetized in radial direction and some magnets 12—at a certain angle.

The magnets 12 may be mounted directly on the shaft 23A or on the back iron. Mounting the magnets 12 directly on the shaft 23A is advantageous as thicker shaft means lower radial deflections of the rotor which in turn allows production of longer machines.

The magnets 12 may be provided with an anti-corrosion coating.

In case the electrical machine is very long it may be difficult to insert the coils 20A-C into the stator slots 15 in traditional way. For such a case manufacturing of the electrical machine can be changed as described below.

As shown in FIG. 7, the stator 13 includes a main preassembled stack of laminations 21 and a plurality of arced segments 30 of back iron.

The coils 20B are first fitted into the slots 15 of laminated stack 21. Then arced segments 30 are installed afterwards. The coils 20B may be pre-formed before being fitted to the laminated stack 21.

The arced segments 30 may be made of axially stacked laminations, sintered magnetic body or compacted magnetic powder body.

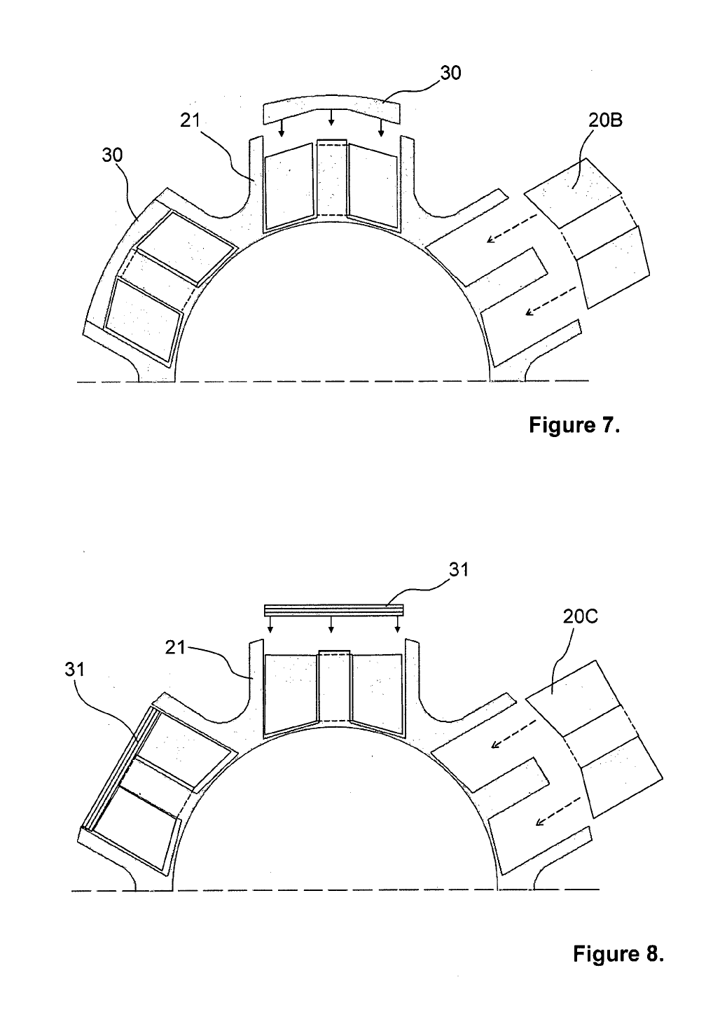

An alternative to the arced segments 30 are segments 31 made of radially stacked laminations 21, as shown in FIG. 8.

In the figure it is shown a flat segment 31 made of radially stacked laminations 21, but the segments 31 may also be made of axially stacked laminations, sintered magnetic body or compacted magnetic powder body (not shown in figure). This alternative will simplify the manufacturing and assembling.

As above, the coils 20C are first fitted into the slots 15 of the laminated stack 21. The flat segments 31 are installed afterwards. The coils 20C may be pre-formed before being fitted to the laminated stack 21.

An alternative for simplifying the insertion of coils 20A-C into the laminated stack 21 for long electrical machines will be described below.

To be able to insert the coils 20A-C into the slots 15 for long electrical machines with small inner diameter, the stator lamination stack 21 can be made of two or more circumferential sections where each section can comprise one or more coils 20A-C.

The coils 20A-C is first fitted into the slots 15 of the laminated stack 21. The stator sections are then joined together creating a circular stator 13.

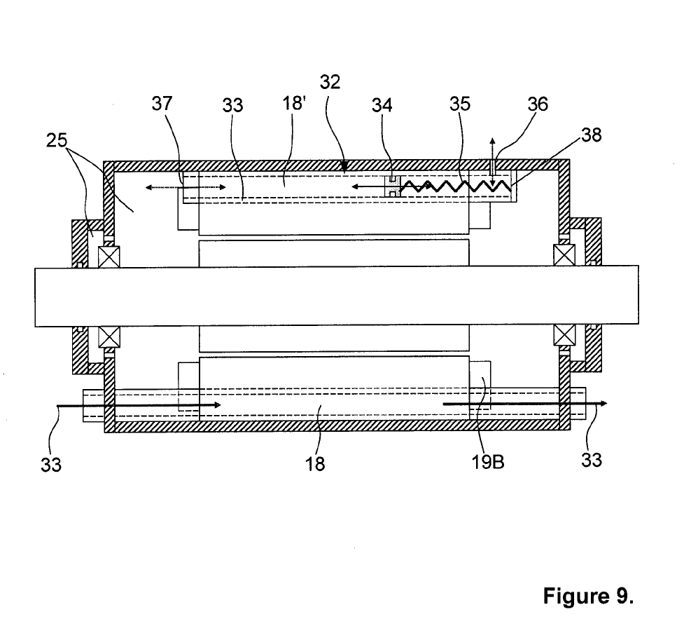

Reference is now made to FIG. 9 which shows an integrated motor protector 32. While some channels 18 may be used for transportation of some substance 33 through the electrical machine, like channel 18 in FIG. 9, other channels may be used for accommodation of a motor protector 32, like channel 18′. A motor protector 32 serving for compensation of pressure is comprised in a channel tube 33, piston 34, spring 35 and hole 36. Fluid 24 inside 25 the electrical machine may move in and out the channel 18′ through an open end 37. External fluid may move in and out the channel 18′ through the hole 36. Another end 38 of the channel 18′ is closed. The substance 33 is shown in the figure flowing through the channel 18.

The electrical machine can be used in generator mode as well as in motor mode. The electrical machine may have integrated speed or position sensor. The electrical machine may have hollow shaft for transportation of external substances.

### Modifications

The stator is shown with round closed channels in the examples, but it is obvious that the channels may have different shapes if desired.

The rotor is shown with threads to circulate cooling fluid inside the electrical machine, but it is obvious that fins, an impeller or other suitable means could be used for the same purpose.

The rotor is shown with a layer for retention and protection to protect the permanent magnets, but it is obvious that the layer can be made of a metallic layer.

1-21. (canceled)

22. An electrical machine, particularly a motor or generator, with at least three phases, comprising a rotor (11) provided with permanent magnets (12) and a stator (13) with slots (15) for coils (20A-C) to provide phase windings, said slots (15) being separated by teeth (16, 17), wherein some of said teeth (16) are carrying coils (20A-C), and some of said teeth (17) are not carrying coils, and wherein said teeth (17) not carrying coils are provided with axial channels (18, 18′) protruding into said teeth (17) not carrying coils and a neighboring back iron so that an area of said channels (18, 18′) inside each of said teeth (17) not carrying coils is comparable to or even larger than an area of said channel (18, 18′) in said back iron.

23. The electrical machine according to claim 22, wherein there are at least twelve of said slots (15), six of said coils, six of said teeth (16) carrying coils, and six of said teeth (17) not carrying coils.

24. The electrical machine according to claim 22, wherein there are six or fewer of said teeth (17) not carrying coils.

25. The electrical machine according to claim 22, wherein said slots (15) are closed by non-magnetic or semi-magnetic slot wedges (19).

26. The electrical machine according to claim 22, wherein an inside (25) of the electrical machine is at least partly filled with a fluid (24) for pressure compensation.

27. The electrical machine according to claim 22, wherein an outer shell of the electrical machine is exposed to a cooling fluid (24) circulating on an inside (25) of the electrical machine.

28. The electrical machine according to claim 22, wherein said rotor (11) is provided with a means (28) to provide internal circulation of said fluid (24).

29. The electrical machine according to one of the claims 22, wherein at least some of said channels (18) form a flow path, extending through the stator (13), for transportation of one or more substances (33) or materials, for example a wellbore fluid.

30. The electrical machine according to claim 22, wherein at least one of said channels (18′) is used for accommodation of a motor protector (31).

31. A rotor (11) comprising a shaft (23A) and permanent magnets (12) attached to said shaft (23A), and wherein the magnets (12) are segmented, a stator (13) with slots (15) for coils (20A-C) to provide phase windings, said slots (15) being separated by teeth (16, 17), wherein some of said teeth (16) are carrying coils (20A-C), and some of said teeth (17) are not carrying coils, and wherein said teeth (17) not carrying coils are provided with axial channels (18, 18′) protruding into said teeth (17) not carrying coils and a neighboring back iron so that an area of said channels (18, 18′) inside each of said teeth (17) not carrying coils is comparable to or even larger than an area of said channel (18, 18′) in said back iron.

32. The rotor according to claim 31, wherein said magnet segments (12) are attached directly to said shaft (23A).

33. The rotor according to claims 31, wherein said magnet segments (12) are magnetized in alternating directions.

34. The rotor according to claim 31, wherein said magnets (12) are provided with an anti-corrosion coating.

35. The rotor according to claim 31, wherein said shaft (23B) is hollow.

36. A manufacturing method for an electrical machine according to claim 22, wherein a stator (13) core is assembled from a main pre-assembled stack of laminations (21) and a plurality of segments (30, 31), and wherein each segment (30, 31) acts as a part of a back iron.

37. The manufacturing method according to claim 36, wherein said stator segments (30, 31) are arced (30) or flat (31).

38. The manufacturing method according to claim 36, wherein said coils (20A-C) are first fitted into slots (15) of said laminated stack and then said segments (30, 31) are installed.

39. The manufacturing method according to claim 37, wherein said segments (30, 31) are made of radially stacked laminations, axially stacked laminations, a sintered magnetic body or a compacted magnetic powder body.

40. The manufacturing method according to claim 36, wherein said stator (13) core comprises two or more circumferential stator sections.

41. The manufacturing method according to claim 40, wherein said coils (20A-C) are first fitted into said slots (15) of laminated stack and then stator sections are joined together.

42. The manufacturing method according to claim 36, wherein said coils (20A-C) are pre-formed before being fitted into a main preassembled stack.
